(19) United States
(12) Patent Application Publication
(10) Pub. No.: US 2008/0261628 A1
(43) Pub. Date: Oct. 23, 2008

(54) INTER-SYSTEM PAGING CONTROL

(75) Inventors: Lee M. Proctor, Cary, IL (US); Matt J. Dillon, Boulder, CO (US); Gerald J. Gutowski, Grayslake, IL (US); Jaime A. Borras, Miramar, FL (US); Zaffer S. Merchant, Parkland, FL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/737,391

(22) Filed: Apr. 19, 2007

(51) Int. Cl. H04Q 7/20

(52) U.S. Cl. 455/458

(57) ABSTRACT

A method, information processing system, and wireless communication system for dynamically updating paging slot cycles associated with a wireless device (104). The method includes monitoring behavior of a wireless device (104) across multiple access networks (122). A set of slot cycles for each access network associated with the wireless device is determined in response to the monitoring (406). The method dynamically updates a set of slot cycle schedules (408) corresponding to the set of slot cycles associated with the wireless device (104) in response to the determining.

### FIELD OF THE INVENTION

The present invention generally relates to the field of wireless communications, and more particularly relates to network procedures for saving battery life on a wireless device in a wireless communication system.

### BACKGROUND

Wireless communication systems have evolved greatly over the past few years. Current wireless communication systems are capable of transmitting and receiving broadband content such as streaming video and audio. Wireless communication systems generally are comprised of wireless devices and access points, referred to as “base stations”, which provide communication services to the wireless devices. Wireless communication systems can also include various access networks that provide multiple services such as voice and data services to its wireless subscribers. Multi-mode devices capable of utilizing these various different types of services usually register and camp on all of the different access networks to maximize service capabilities. However, this greatly reduces the amount of standby battery life available to the multi-mode device. Current wireless communication systems do not provide an advantageous mechanism to overcome this battery-life loss.

Therefore a need exists to overcome the problems with the prior art as discussed above.

### SUMMARY

Briefly, in accordance with the present invention, disclosed are a method, information processing system, and wireless communication system for dynamically updating paging slot cycles associated with a wireless device. The method includes monitoring behavior of a wireless device across multiple access networks. A set of slot cycles for each access network associated with the wireless device is determined in response to the monitoring, and a set of slot cycle schedules corresponding to the set of slot cycles associated with the wireless device is dynamically updated in response to the determining.

In another embodiment, an information processing system dynamically updates paging slot cycles associated with a wireless device. The information processing system comprises a memory and a processor that is communicatively coupled to the memory. A paging controller is communicatively coupled to the memory and the processor. The paging controller is adapted to monitor behavior of a wireless device across multiple access networks. A set of slot cycles for each access network associated with the wireless device is determined in response to the monitoring, and a set of slot cycle schedules corresponding to the set of slot cycles associated with the wireless device is dynamically updated in response to the determining.

In yet another embodiment, a wireless communication system for dynamically updating paging slot cycles associated with a wireless device is disclosed. The wireless communication system comprises a plurality of base stations. The wireless communication system also includes a plurality of wireless communication devices. Each wireless communication device is communicatively coupled to at least one base station. At least one information processing system is communicatively coupled to at least one base station and at least one wireless communication device. The at least one information processing system comprises a paging controller.

The paging controller is adapted to monitor behavior of a wireless device across multiple access networks. A set of slot cycles for each access network associated with the wireless device is determined in response to the monitoring. A set of slot cycle schedules corresponding to the set of slot cycles associated with the wireless device is dynamically updated in response to the determining.

An advantage of the foregoing embodiments of the present invention is that an advantageous paging control system is provided. The dynamic paging controller of multiple embodiments of the present invention coordinates slot cycles across multiple access networks so that wake-up times for a wireless device camped on each system do not clash. Such a paging controller may also determine the optimal system on which to page the wireless device based on knowledge of the slot cycles associated with the device and other criteria. Therefore, the paging controller of multiple embodiments of the present invention dynamically adjusts the paging duty cycle associated with a wireless device to optimize user experience and optimize the device standby battery life.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a wireless communications system according to an embodiment of the present invention;

FIG. 2 is a block diagram illustrating an information processing system according to an embodiment of the present invention;

FIG. 3 is a block diagram illustrating a wireless communication device according to an embodiment of the present invention;

FIG. 4 is an operational flow diagram illustrating a general process of dynamically updating paging slot cycles associated with a wireless device according to an embodiment of the present invention;

FIG. 5 is an operational flow diagram illustrating a more detailed process of dynamically updating a paging schedule associated with a wireless device according to an embodiment of the present invention; and

FIG. 6 is an operational flow diagram illustrating various additional processes for updating a paging schedule associated with a wireless device according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of embodiments of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term coupled, as used herein, is defined as connected, although not necessarily directly, and not necessarily mechanically.

The term “wireless communication device” is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Wireless Communications System

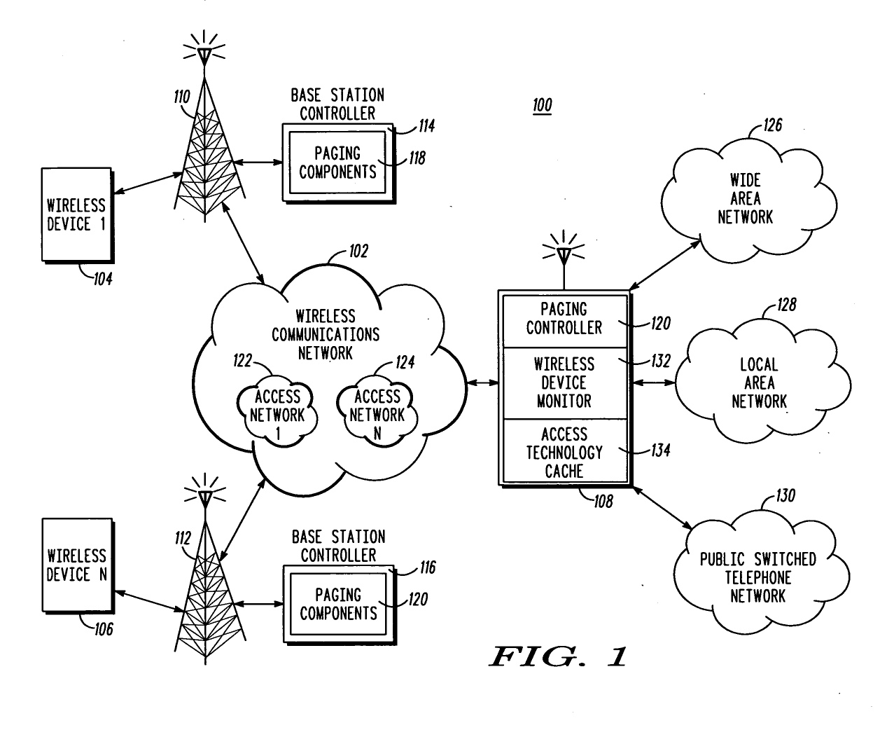

According to an embodiment of the present invention, as shown in FIG. 1, a wireless communications system 100 is illustrated. FIG. 1 shows a wireless communications network 102 that connects wireless communication devices 104, 106, to each other or to one or more information processing systems 108. The wireless communications network 102, in one embodiment, comprises one or more access networks 122, 124 such as circuit services networks, packet data networks, and the like. The wireless communications network 102, according to the present example, comprises a mobile phone network, a mobile text messaging device network, a pager network, or the like.

Further, the communications standard of the wireless communications network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA), IEEE 802.16 family of standards, Orthogonal Frequency Division Multiplexing (OFDM), Orthogonal Frequency Division Multiple Access (OFDMA), Wireless LAN (WLAN), WiMAX or the like. Other applicable communications standards include those used for Public Safety Communication Networks including TErrestrial TRunked Radio (TETRA). Additionally, the wireless communications network 102 also comprises text messaging standards, for example, Short Message Service (SMS), Enhanced Messaging Service (EMS), Multimedia Messaging Service (MMS), or the like. The wireless communications network 102 also allows for push-to-talk over cellular communications between capable wireless communication devices.

The wireless network 102 supports any number of wireless communication devices 104, 106, which can be single mode or multi-mode devices. Multi-mode devices are capable of communicating on various access networks such as circuit services networks, packet data networks, and the like. The support of the wireless network 102 includes, but is not limited to, support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone.

More generally, a smartphone can be a mobile telephone that has additional application processing capabilities. In one embodiment, wireless communications network 102 allows for mesh networking between the wireless communication devices 104, 106. In one embodiment, the wireless network 102 is capable of broadband wireless communications utilizing time division duplexing (“TDD”) as set forth, for example, by the IEEE 802.16e standard. The duplexing scheme TDD allows for the transmissions of signals in a downstream and upstream direction using a single frequency. Another possible duplex scheme is Frequency Division Duplex, in which downstream and upstream communications can happen at the same time, but at different frequencies.

It should be noted that the present invention is not limited to an 802.16e system, or more generally a TDD system. Other such standards such as 3GPP (Long Term Evolution or UMTS-TDD version), 3GPP2 evolution, 802.20, Fourth Generation (“4G”), and the like are also applicable. The present invention is applicable to any wireless communication system that transmits, among other things, broadcast information in a non-continuous manner and implements an idle mode period for wireless devices subscribing to the system.

The wireless system 100 also includes one or more base stations 110, 112 that include a base station controller (“BSC”) 114, 116. Each base station controller 114, 116, in one embodiment, includes paging components 118, 120 that perform various paging functions and communicate with a paging controller 120 at the information processing system 108.

The wireless communications system 100 also includes one or more information processing systems 108 such as a central server that maintain and process information for all wireless devices 104, 106 communicating on the wireless network 102. Additionally, each information processing system 108 communicatively couples the wireless communications devices 104, 106 to a wide area network 126, a local area network 128, and a public switched telephone network 130 through the wireless communications network 102. Each of these networks has the capability of sending data, for example, a multimedia text message, to the wireless devices 104, 106.

Additionally, the information processing system 108 also monitors and manages wireless device activity on the various access networks 122, 124 included within the wireless communications network 102. Alternatively, one or more additional information processing systems can manage one or more of the access networks 122, 124. In another embodiment, the information processing server 108 includes a paging controller 120. The paging controller 120, in one embodiment, controls, among other things, the paging functions such as paging slot cycles and wireless device wake-up times across the various access networks of a specific paging group or for the wireless communication system 100. The function of the paging controller 120 is discussed in greater detail below. It should be noted that the paging controller 120 can reside at any information processing system communicatively coupled to the wireless communications network 102.

Inter-System Paging Control

As discussed above, multi-mode wireless devices are capable of communicating on more than one type of access network. Therefore, to maximize service capabilities, multi-mode wireless devices register and camp on all access networks, which unnecessarily wastes stand-by battery life. Conserving battery resources at the wireless device is essential in order to prolong the time device can operate without requiring its battery to be recharged. A common method of extending battery life in wireless communication systems is to utilize an “idle-mode”. During normal operation, the wireless communication network 102 tracks the movements of each active wireless device 104, 106 down to the base station level, i.e., it is constantly aware of which base station 110, 112 each wireless device 104, 106 is connected to at any given time. When a wireless device 104, 106 is not actively engaged in some sort of communication with the network, this level of granularity is no longer needed and the network can elect to track the wireless device 104, 106 at a much coarser level. The wireless device 104, 106 can, in turn, switch off its radio receiver and transmitter and thus conserve battery resources. This is done by allowing the wireless device to enter idle mode. Typically in idle mode, the location of a device is tracked by the network 102 at the level of group of base stations, typically called a “paging group”.

An idling mobile device can switch off its radio and other functions and is not required to monitor every transmission by the network. However, an idling wireless device is still required to periodically wake up and monitor the network's transmissions for a short time, typically called the “paging listening interval”. This is done so that the network can inform the wireless device 104, 106 of any incoming traffic. When the wireless device 104, 106 is in a sleep mode, this is commonly referred to as a “sleeping time interval”. The schedule and relative duration of sleeping to paging listening intervals can be different for each wireless device 104, 106, but typically remains unchanged as long as the wireless device 104, 106 stays within the same paging group.

A wireless device 104, 106, when it enters idle mode, is given a particular sleeping and paging interval schedule by the base station 110, 112. A listening/paging interval schedule is typically defined through a set of parameters that are communicated to each idling wireless device 114, 116. These parameters typically comprise of a paging frequency and a paging offset, which jointly define how often the wireless device 104, 106 is expected to become available for paging and traffic notifications from the network. Typically, a number of schedules, for different levels of availability, are configured in each paging group and the wireless device 104, 106 is given one of the available schedules when it enters idle mode. The wireless device 104, 106 is also typically responsible for monitoring if it has moved into the area of a different base station, but is only required to notify the network when it roams into the area of a different paging group.

In modern wireless communication systems, the base station 110, 112 is typically responsible for regulating wireless transmissions within its area (within its cell). This is typically done by enforcing some slotted time structure in which the schedule for transmissions and receptions for the next unit of time is periodically communicated by a base station 110, 112 to all the wireless devices in its cell a slot cycle is the time when the wireless device 104, 106 communicates with the base station 110, 112. In a CDMA system, the time between two consecutive slots monitored by the same wireless device 104, 106 is called a cycle. In most commercial networks, a cycle is set to 32 or 64 slots, i.e., 2.56 or 5.12 seconds, respectively. A wireless device 104, 106 is assigned to a particular slot in a cycle based on its International Mobile Station Identifier (“IMSI”).

Within a cell, the time unit used for regulating transmissions is commonly referred to as a “frame”. At the beginning of each frame a base station 110, 112 transmits a minimal amount of identifying information to make each wireless device 104, 106 of the origin of the communicated schedule. This information is kept at a minimum due to the increased frequency of transmissions. For example, typical frame sizes are in the order of 5 msec or even 1 msec. Transmitting a large amount of information at the beginning of each frame unnecessarily increases overhead and wastes system resources. Information, such as the paging group to which a base station belongs and other details about the structure of the upstream and downstream channels and the settings currently in use, are reserved for larger system broadcast transmissions, which happen much less frequently.

Various embodiments of the present invention provide an advantageous paging control method that increases battery-life of wireless devices. For example, the paging controller 120 situated at a network entity such as the information processing system 108 can dynamically adjust the paging cycles corresponding to a wireless device 104, 106 for the various access networks 108 associated with that device. In one embodiment, the paging controller 120 includes a wireless device monitor 132 for monitoring and tracking the behavior of a wireless device 104, 106 within the various access networks 122, 124. In one embodiment, the paging controller 120 acts as a proxy on behalf of the wireless device 104, 106.

For example, in one embodiment, during “off” hours when the wireless device 104, 106 is not in use, the information processing system via the dynamic paging controller 120 minimizes the paging of the wireless device 104, 106 device to maximize standby time. In another example, one or more subscribed to services of the wireless device 104, 106 such as Push-To-Talk (“PTT”) can be available on multiple access networks. However, the wireless device 104, 106 may only be registered on one of these networks for PTT service. Therefore, the dynamic paging controller 120 can adjust the paging interval on the other systems to a longer duty cycle (i.e. for telephony) to improve the standby time.

In one embodiment, the paging controller 120 monitors the behavior such as usage patterns of a wireless device 104, 106. The paging controller 120 can then uses its knowledge of historic usage patterns associated with the device with respect to a last known network and can fine tune this gross time line with a last known location/base station wherein the coverage of the respective networks is known via successful paging history.

In another example, the dynamic paging controller 120 adjusts the paging duty cycle based on the location of the wireless device 104, 106, time-of-day, application, and the like to maximize the user experience and battery life. Additionally, if the wireless device 104, 106 is in standby on a super sleep paging cycle, any service page such as a PTT page that is sent to the device 104, 106 is missed by the device 104, 106. However, the dynamic paging controller 104, 106 stores any pages received during a super sleep mode. These pages are then sent to device 104, 106 in a subsequent paging cycle. In another embodiment, the dynamic paging controller 120 can use its knowledge of the slot cycles associated with the wireless device 104, 106, to determine the network on which to send the page so as to send the page out as soon as possible.

In order to minimize storage in the destination network, the dynamic paging controller 120 may retain the page until just before the next wake up cycle for the device on the destination network. The dynamic paging controller 120 then transmits to the destination network so that it arrives just in time for transmission to the device 104. For example, the dynamic paging controller 120 determines the network on which the wireless device 104, 106 is due to wake up next and sends the page on that network. The dynamic paging controller 120 can determine the wake up times of the device 104 on the serving networks 122, 124, based on the initial setting of the first wake up period and the periodicity of the slot cycles. By comparing the determined wake up times with a current system time the dynamic paging controller can determine which network the device 104 will wake up on next. In one embodiment the dynamic paging controller 120 is responsible for both the first wake up period and the periodicity. However, an alternative embodiment is for the access networks 122, 124 setting there own slot cycle parameters, communicating the parameters to the dynamic paging controller 120 and the dynamic paging controller coordinating and adjusting the slot cycle parameters as necessary.

In another embodiment, when a wireless device 104, 106 powers-up and registers in a muti-access network environment it registers with the information processing system 108. The wireless device 104, 106 then registers for services on the different access networks based on a device rule set. For instance, PTT service on access Network A, Telephony service on access Network B, and Hi-speed data service on access Network C. Acting on behalf of the device, and based on a predetermined rule set, the information processing system 108 (acting as a proxy server) can adjust the paging duty cycle via the dynamic paging controller 120 for the different access networks to maximize battery life.

The dynamic paging controller 126, in one embodiment, also ensures adequate offsetting of slot cycles so that the wireless device 104, 106 is not expected to search on the multiple networks at the same time. For example assume a slot cycle periodicity of T on Network A and a slot cycle with a lot higher periodicity is desired on Network B. To ensure there is no clashing, the slot cycle on Network B is set to a multiple of T with a starting offset point, e.g., periodicity 5T+starting offset T/2. The dynamic paging controller 120 also selects the same network to page the wireless device 104, 106 in which the device is currently active in (i.e., learned information of the wireless device 104, 106). If the wireless device 104, 106 is not active in any network, the wireless device 104, 106 can check an access technology cache 134 that timestamps the last (end of connection) use of a network.

For example, using the IMSI assigned for GSM cellular or in IEEE-based, the CID (Connection ID) (or list of CIDs, muti-session applications running to the device, and the like) that currently exist for the device to page on the current (or most recent, e.g., 2 minutes) active network effectively minimizes scanning. It should be noted that scanning in this context is scanning for pages on the networks that are enabled in the device 104, 106. The above values of IMSI and CID may have different but similar lifetimes of “goodness” or “freshness”. These CID and IMSI/TMSI values are more temporal than the IMEI and can be burned in MAC addresses permanently attached to a product by the manufacturer. In these examples, the IMEI or the MAC addresses are known as burned-in addresses” (BIA) or sometimes as “Universally Administered Addresses” (UAA).

WiMAX systems are typically connection oriented where a CID is direction specific (e.g., downlink and uplink) and is only valid for a specific connection instance of the 802.16 MAC (medium access control) layer. In WiMAX, a wireless device 104, 106 is most likely to be active in a data transfer state when a primary management connection is set up for the device 104, 106 by the base station 110. The WiMAX base station 110 typically reserves several CIDs for each device 104, 106 (basic, primary and secondary management) connections. Thus, a paging controller 120, minimally updated with the presence of, or the actual primary management connection, can take advantage of delivering pages via WiMAX technology. When WiMAX primary management connection exists, the controller 120 can ensure timely and battery efficient delivery of a page knowing in advance that the device is in a WiMAX connection with a base station 110 and needs to respond to MAC management messaging in opposed to a less-fresh, connection-less GSM circuit session.

Furthermore, the dynamic paging controller 120 can facilitate monitoring of the wireless device 104, 106 and its paging cycles to ensure load mediation such that when a threshold T indicating a specific network is loaded (number of users in fixed bandwidth application, backhaul BW is consumed, non-constant bit rate services, or QoS for a Service Level Agreement (“SLA”) cannot tolerate another user) subsequent paging may then be re-directed to another network. AN SLA is indicative of the service type offered by an operator's network typically advertised when a device 104, 106 is roaming onto another operator's network. Here the “service level” for the “home” users may take priority in resource allocation and management algorithms. Thus, the bandwidth and resource consumption is assessed for paging a new (potentially a roaming device) device, perhaps cannot be serviced as defined in a SLA between carriers. Further, the paging controller 120 may possess knowledge of a minimum impact of a basic session (for example) on a WiMAX network and the minimum service that would be guaranteed for a specific device user class on that roaming network via the SLA.

As can be seen, various embodiments of the present invention provide an advantageous paging control system. The dynamic paging controller of various embodiments of the present invention coordinates slot cycles across multiple access networks so that wake-up times for a wireless device camped each system does not clash. Such a paging controller may also determine the optimal system on which to page the wireless device based on knowledge of the slot cycles associated with the device and other criteria. Therefore, the paging controller of various embodiments of the present invention dynamically adjusts the paging duty cycle associated with a wireless device to optimize user experience and optimize the device standby battery life.

Information Processing System

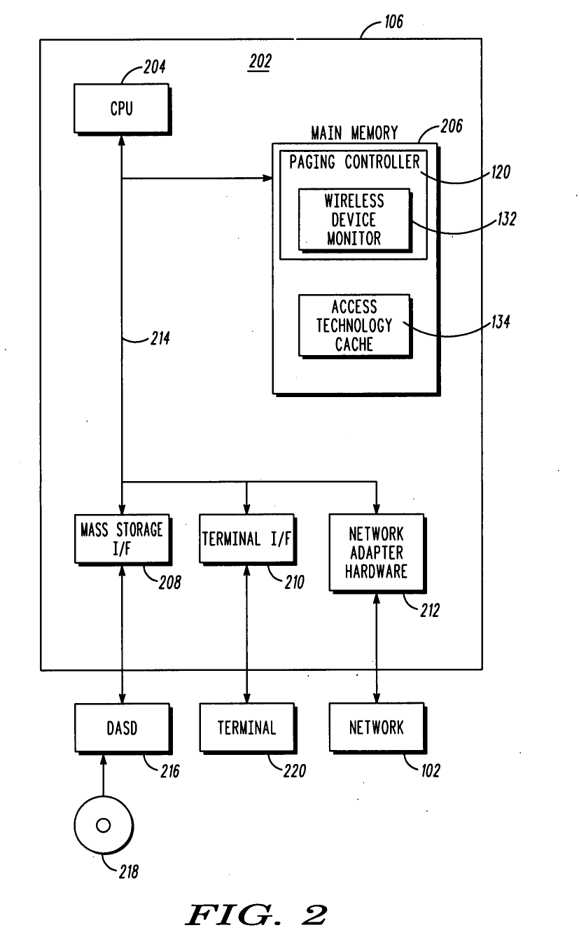

FIG. 2 is a block diagram illustrating a more detailed view of the information processing system according to an embodiment of the present invention. Although the following discussion is with respect to the information processing system 108, it is also applicable any information processing system communicatively coupled to the wireless communications network 102. The information processing system 108 is based upon a suitably configured processing system adapted to implement the embodiment of the present invention. For example, a personal computer, workstation, or the like, may be used. The information processing system 108 includes a computer 202. The computer 202 has a processor 204 that is connected to a main memory 206, a mass storage interface 208, a terminal interface 210, and a network adapter hardware 212. A system bus 214 interconnects these system components.

The main memory 206 includes the paging controller 120, which comprises the wireless device monitor 132 and the access technology cache 132. These components have been discussed in greater detail above. Although illustrated as concurrently resident in the main memory 206, it is clear that respective components of the main memory 206 are not required to be completely resident in the main memory 206 at all times or even at the same time. One or more of these components can be implemented as hardware. In one embodiment, the information processing system 108 utilizes conventional virtual addressing mechanisms to allow programs to behave as if they have access to a large, single storage entity, referred to herein as a computer system memory, instead of access to multiple, smaller storage entities such as the main memory 206 and data storage device 216. The data storage device 216 can store data on a hard-drive or media such as a CD 216. Note that the term “computer system memory” is used herein to generically refer to the entire virtual memory of the information processing system 108.

Although only one CPU 204 is illustrated for computer 202, computer systems with multiple CPUs can be used equally effectively. Embodiments of the present invention further incorporate interfaces that each includes separate, fully programmed microprocessors that are used to off-load processing from the CPU 204. Terminal interface 210 is used to directly connect one or more terminals 220 to computer 202 to provide a user interface to the BSC 114. These terminals 220, which are able to be non-intelligent or fully programmable workstations, are used to allow system administrators and users to communicate with the information processing system 108. The terminal 220 is also able to consist of user interface and peripheral devices that are connected to computer 202 and controlled by terminal interface hardware included in the terminal I/F 210 that includes video adapters and interfaces for keyboards, pointing devices, and the like.

An operating system (not shown) included in the main memory is a suitable multitasking operating system such as Linux, UNIX, Windows XP, and Windows Server 2003. Embodiments of the present invention are able to use any other suitable operating system. Some embodiments of the present invention utilize architectures, such as an object oriented framework mechanism, for executing instructions of the components of operating system (not shown) on any processor located within the information processing system 108.

The network adapter hardware 212 is used to provide an interface to the network 102. Embodiments of the present invention are able to be adapted to work with any data communications connections including present day analog and/or digital techniques or via a future networking mechanism. Although the embodiments of the present invention are described in the context of a fully functional computer system, those of ordinary skill in the art will appreciate that embodiments are capable of being distributed as a program product via floppy disk, e.g., CD/DVD 218, or other form of recordable media, or via any type of electronic transmission mechanism.

Wireless Communication Device

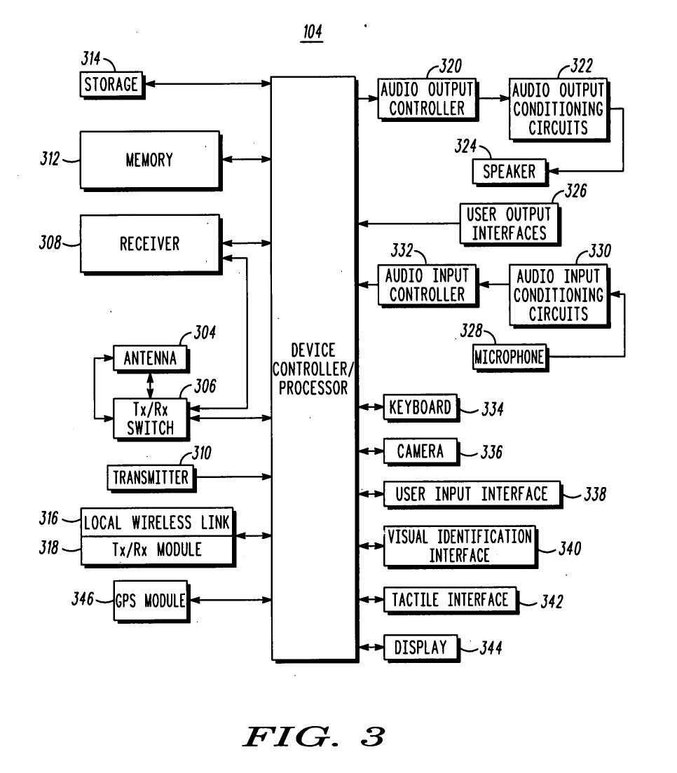

FIG. 3 is a block diagram illustrating a more detailed view of the wireless communication device 104. In one embodiment, the wireless communication device 104 is a multi-mode device as discussed above. The wireless communication device 104 operates under the control of a device controller/processor 302 that controls the sending and receiving of wireless communication signals. In receive mode, the device controller 302 electrically couples an antenna 304 through a transmit/receive switch 306 to a receiver 308. The receiver 308 decodes the received signals and provides those decoded signals to the device controller 302.

In transmit mode, the device controller 302 electrically couples the antenna 304, through the transmit/receive switch 306, to a transmitter 310. The device controller 302 operates the transmitter and receiver according to instructions stored in the memory 312. These instructions include, for example, a neighbor cell measurement-scheduling algorithm. The wireless communication device 104 also includes non-volatile storage memory 314 for storing, for example, an application waiting to be executed (not shown) on the wireless communication device 104. The wireless communication device 104, in this example, also includes an optional local wireless link 316 that allows the wireless communication device 104 to directly communicate with another wireless device without using a wireless network (not shown). The optional local wireless link 316, for example, is provided by Bluetooth, Infrared Data Access (IrDA) technologies, or the like. The optional local wireless link 316 also includes a local wireless link transmit/receive module 318 that allows the wireless device 104 to directly communicate with another wireless communication device.

The wireless communication device 104 of FIG. 3 further includes an audio output controller 320 that receives decoded audio output signals from the receiver 308 or the local wireless link transmit/receive module 318. The audio controller 320 sends the received decoded audio signals to the audio output conditioning circuits 322 that perform various conditioning functions. For example, the audio output conditioning circuits 322 may reduce noise or amplify the signal. A speaker 324 receives the conditioned audio signals and allows audio output for listening by a user. The audio output controller 320, audio output conditioning circuits 322, and the speaker 324 also allow for an audible alert to be generated notifying the user of a missed call, received messages, or the like. The wireless communication device 104 further includes additional user output interfaces 326, for example, a head phone jack (not shown) or a hands-free speaker (not shown).

The wireless communication device 104 also includes a microphone 328 for allowing a user to input audio signals into the wireless communication device 104. Sound waves are received by the microphone 328 and are converted into an electrical audio signal. Audio input conditioning circuits 330 receive the audio signal and perform various conditioning functions on the audio signal, for example, noise reduction. An audio input controller 332 receives the conditioned audio signal and sends a representation of the audio signal to the device controller 302.

The wireless communication device 104 also comprises a keyboard 334 for allowing a user to enter information into the wireless communication device 104. The wireless communication device 104 further comprises a camera 336 for allowing a user to capture still images or video images into memory 312. Furthermore, the wireless communication device 104 includes additional user input interfaces 338, for example, touch screen technology (not shown), a joystick (not shown), or a scroll wheel (not shown). In one embodiment, a peripheral interface (not shown) is also included for allowing the connection of a data cable to the wireless communication device 104. In one embodiment of the present invention, the connection of a data cable allows the wireless communication device 104 to be connected to a computer or a printer.

A visual notification (or indication) interface 340 is also included on the wireless communication device 104 for rendering a visual notification (or visual indication), for example, a sequence of colored lights on the display 344 or flashing one or more LEDs (not shown), to the user of the wireless communication device 104. For example, a received multimedia message may include a sequence of colored lights to be displayed to the user as part of the message. Alternatively, the visual notification interface 340 can be used as an alert by displaying a sequence of colored lights or a single flashing light on the display 344 or LEDs (not shown) when the wireless communication device 104 receives a message, or the user missed a call.

The wireless communication device 104 also includes a tactile interface 342 for delivering a vibrating media component, tactile alert, or the like. For example, a multimedia message received by the wireless communication device 104, may include a video media component that provides a vibration during playback of the multimedia message. The tactile interface 342, in one embodiment, is used during a silent mode of the wireless communication device 104 to alert the user of an incoming call or message, missed call, or the like. The tactile interface 342 allows this vibration to occur, for example, through a vibrating motor or the like.

The wireless communication device 104 also includes a display 344 for displaying information to the user of the wireless communication device 104 and an optional Global Positioning System (GPS) module 346 The optional GPS module 346 determines the location and/or velocity information of the wireless communication device 104. This module 346 uses the GPS satellite system to determine the location and/or velocity of the wireless communication device 104. Alternative to the GPS module 346, the wireless communication device 104 may include alternative modules for determining the location and/or velocity of wireless communication device 104, for example, using cell tower triangulation and assisted GPS.

Process of Dynamically Updating Paging Intervals

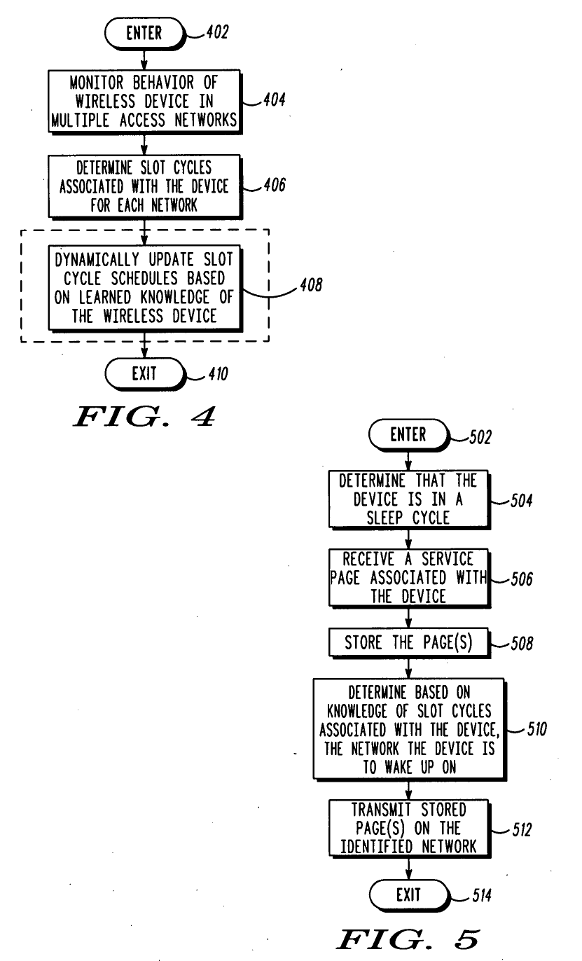

FIG. 4 is an operational flow diagram illustrating a process of dynamically updating paging intervals associated with a wireless device 104. The operational flow diagram of FIG. 4 begins at step 402 and flows directly to step 404. The paging controller 120, at step 404, monitors the behavior of one or more wireless devices across multiple access networks 122, 124. The paging controller 120, at step 406, determines the slot cycles corresponding to the wireless device 104 for each access network associated with the wireless device 104. The paging controller 120, at step 408, dynamically updates slot cycle schedules based on the learned knowledge of the wireless device 104. The control flow then exits at step 410.

A More Detailed Process of Dynamically Updating Paging Intervals

FIG. 5 is an operational flow diagram illustrating a more detailed process of dynamically updating paging intervals associated with a wireless device 104. In particular, the operational flow diagram of FIG. 5 shows a process of updating slot cycles based on receiving pages while the wireless device 104 is in a sleeping cycle. The operational flow diagram of FIG. 5 begins at step 502 and flows directly to step 504.

The paging controller 120, at step 504, determines that the wireless device 104 is in a sleep cycle. The paging controller 120, at step 506, receives a service page associated with the wireless device 104. The paging controller 120, at step 508, stores the received page(s). The paging controller 120, at step 510, determines, based on knowledge of slot cycles associated with the wireless device 104, the network on which the wireless device 104 is to wake up on. The paging controller 120, at step 512, transmits the stored page(s) on the identified network. The control flow then exits at step 514.

Additional Examples of Dynamically Updating Paging Intervals

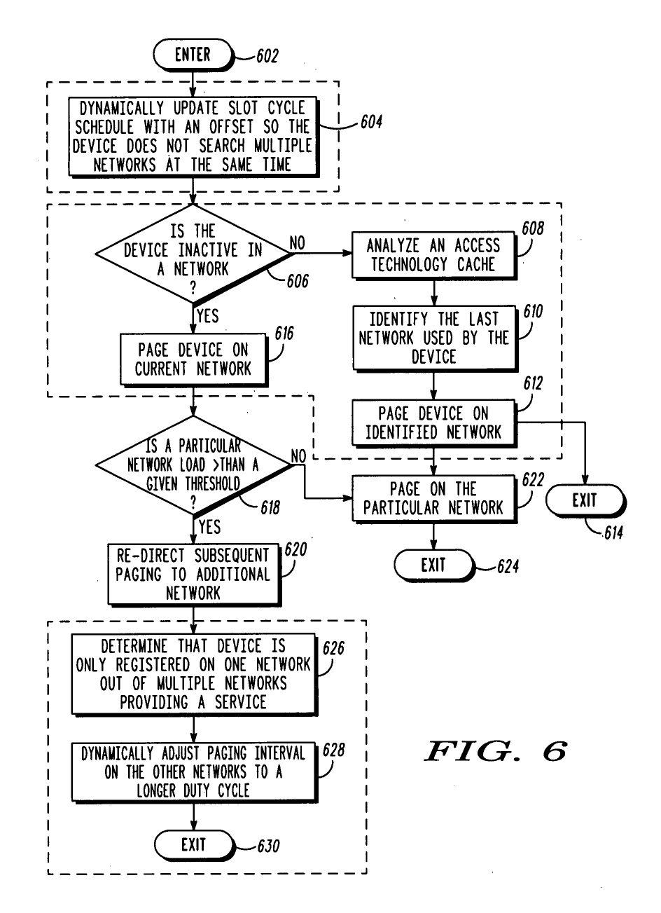

FIG. 6 is an operational flow diagram illustrating various processes of dynamically updating paging intervals associated with a wireless device 104. The operational flow diagram of FIG. 6 begins at step 602 and flows directly to step 604. It should be noted that each dashed box in FIG. 6 represents a different process of step 408 in FIG. 4. The paging controller 120, at step 604, dynamically updates slot cycle schedules corresponding to a wireless device 104 with an offset so that the wireless device 104 does not search multiple access networks 122, 124 at the same time. In another example, the paging controller 120, at step 606, determines if the wireless device 104 is active in an access network 122, 124. If the result of this determination is positive, the paging controller 120, at step 616, pages the wireless device 104 in its current network.

If the result of this determination is negative, the paging controller 120, at step 608, analyzes an access technology cache 134. The paging controller 120, at step 610, identifies the last network used by the wireless device 104. The paging controller 120, at step 612, pages the wireless device 104, on the identified network. The control flow then exits at step 614. In yet another example, the paging controller 120, at step 618, determines if a load of a particular access network 122, 124 is greater than a given threshold. If this determination is positive, the paging controller 120, at step 620, redirects subsequent paging to an additional access network 122, 124. If the result of this determination is positive, the paging controller 120, at step 622, pages on that particular network. The control flow then exits at step 624. In another example, the paging controller 120, at step 626, determines that the wireless device 104 is only registered on one network out of multiple networks providing a subscribed to service. The paging controller 120, at step 628, dynamically adjusts the paging interval on the non-registered networks to a longer duty cycle. The control flow then exits at step 30.

Non-Limiting Examples

The present invention can be realized in hardware, software, or a combination of hardware and software. A system according to an embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information processing system, for dynamically updating paging slot cycles associated with a wireless device, the method comprising:
monitoring behavior of a wireless device across multiple access networks;
determining, in response to the monitoring, a set of slot cycles for each access network associated with the wireless device; and
dynamically updating, in response to the determining, a set of slot cycle schedules corresponding to the set of slot cycles associated with the wireless device.

2. The method of claim 1, wherein the dynamically updating further comprises:
determining that the wireless device is in a sleeping time interval;
receiving at least one service page associated with the wireless device;
storing the at least one service page;
determining an access network on which the wireless device is to wake up on next; and
transmitting the at least one service page on the determined access network.

3. The method of claim 1, wherein the dynamically updating further comprises:
dynamically updating the set of slot cycle schedules with an offset that prevents the wireless device from searching on more than one of the access networks at a time.

4. The method of claim 1, wherein the dynamically updating further comprises:
determining if the wireless device is active in an access network;
analyzing, in response to the wireless device failing to be active in an access network, an access technology cache;
identifying, in response to the analyzing, a most recent access network used by the wireless device; and
paging the wireless device on the identified most recently used access network.

5. The method of claim 1, wherein the dynamically updating further comprises:
determining that a current load of one of the access networks is greater than a given threshold; and
redirecting, in response to the determining, paging functions associated with the access network to another access network capable of providing a substantially similar service to the wireless device.

6. The method of claim 1, wherein the dynamically updating further comprises:
determining that the wireless device is only registered on one network out of multiple networks that provide a substantially similar service; and
dynamically updating, in response to the determining, a paging interval on non-registered access networks so that the paging interval includes a longer duty cycle than the registered network.

7. An information processing system for dynamically updating paging slot cycles associated with a wireless device, the information processing system comprising:
a memory;
a processor communicatively coupled to the memory; and
a paging controller communicatively coupled to the memory and the processor, wherein the paging controller is adapted to:
monitor behavior of a wireless device across multiple access networks,
determine, in response to the monitoring, a set of slot cycles for each access network associated with the wireless device, and
dynamically update, in response to the determining, a set of slot cycle schedules corresponding to the set of slot cycles associated with the wireless device.

8. The information processing system of claim 7, wherein the dynamically updating further comprises:
determining that the wireless device is in a sleeping time interval;
receiving at least one service page associated with the wireless device;
storing the at least one service page;
determining an access network on which the wireless device is to wake up on next; and
transmitting the at least one service page on the determined access network.

9. The information processing system of claim 7, wherein the dynamically updating further comprises:
dynamically updating the set of slot cycle schedules with an offset that prevents the wireless device from searching on more than one of the access networks at a time.

10. The information processing system of claim 7, wherein the dynamically updating further comprises:
determining if the wireless device is active in an access network;
analyzing, in response to the wireless device failing to be active in an access network, an access technology cache;
identifying, in response to the analyzing, a most recent access network used by the wireless device; and
paging the wireless device on the identified most recently used access network.

11. The information processing system of claim 7, wherein the dynamically updating further comprises:
determining that a current load of one of the access networks is greater than a given threshold; and
redirecting, in response to the determining, paging functions associated with the access network to another access network capable of providing a substantially similar service to the wireless device.

12. The information processing system of claim 7, wherein the dynamically updating further comprises:
determining that the wireless device is only registered on one network out of multiple networks that provide a substantially similar service; and
dynamically updating, in response to the determining, a paging interval on non-registered access networks so that the paging interval includes a longer duty cycle than the registered network.

13. A wireless communication system for dynamically updating paging slot cycles associated with a wireless device, the wireless communications system comprising:
a plurality of base stations;
a plurality of wireless communication devices, wherein each wireless communication device is communicatively coupled to at least one base station; and
at least one information processing system communicatively coupled to at least one base station and at least one wireless communication device, wherein the at least one information processing system comprises a paging controller adapted to:
monitor behavior of a wireless device across multiple access networks;
determine, in response to the monitoring, a set of slot cycles for each access network associated with the wireless device; and
dynamically update, in response to the determining, a set of slot cycle schedules corresponding to the set of slot cycles associated with the wireless device.

14. The wireless communications system of claim 13, wherein the dynamically updating further comprises:
determining that the wireless device is in a sleeping time interval;
receiving at least one service page associated with the wireless device;
storing the at least one service page;
determining an access network on which the wireless device to wake up on; and
transmitting the at least one service page on the determined access network.

15. The wireless communications system of claim 13, wherein the dynamically updating further comprises:
dynamically updating the set of slot cycle schedules with an offset that prevents the wireless device from searching on more than one of the access networks at a time.

16. The wireless communications system of claim 13, wherein the dynamically updating further comprises:
determining if the wireless device is active in an access network;
analyzing, in response to the wireless device failing to be active in an access network, an access technology cache;
identifying, in response to the analyzing, a most recent access network used by the wireless device; and
paging the wireless device on the identified most recently used access network.

17. The wireless communications system of claim 13, wherein the dynamically updating further comprises:
determining that a current load of one of the access networks is greater than a given threshold; and
redirecting, in response to the determining, paging functions associated with the access network to another access network capable of providing a substantially similar service to the wireless device.

18. The wireless communications system of claim 13, wherein the dynamically updating further comprises:
determining that the wireless device is only registered on one network out of multiple networks that provide a substantially similar service; and
dynamically updating, in response to the determining, a paging interval on non-registered access networks so that the paging interval includes a longer duty cycle than the registered network.
